(19) United States
(12) Patent Application Publication
(10) Pub. No.: US 2007/0172655 A1
(43) Pub. Date: Jul. 26, 2007

(54) Core for proppant and process for its production

(75) Inventors: Lars Leidolph, Erfurt (DE); Ulrich Weitz, Berlin (DE); Toralf Rensch, Weimar (DE)

Correspondence Address: HEXION SPECIALTY CHEMICALS, INC., 1600 SMITH STREET, P.O. BOX 4500, HOUSTON, TX, 77210-4500, US

(73) Assignee: Hexion Specialty Chemicals, Inc.

(21) Appl. No.: 11/651,701

(22) Filed: Jan. 10, 2007

(30) Foreign Application Priority Data
Jan. 23, 2006 (DE) 10 2006 003 295.0

(51) Int. Cl. B32B 5/16; C04B 35/10

(52) U.S. Cl. 428/402; 501/127

(57) ABSTRACT

Disclosed is a proppant core, having low density and high strength and a process for its production. The proppant core is especially useful in crude oil and natural gas extraction. The proppant properties are achieved by virtue of the raw material mixture consisting of melt phase former and at least one further component and containing less than 35% Al₂O₃. The process includes mixing the raw material components, homogenizing, granulating and then thermally treating the cores.

### RELATED APPLICATION DATA

This application claims the benefit of German Patent Application No. 10 2006 003 295.0 filed Jan. 23, 2006, the entire contents of which are hereby incorporated by reference.

### FIELD OF THE INVENTION

The invention relates to a core, especially for use as a proppant in crude oil and natural gas extraction according to the preamble of claim 1. The invention further relates to a process for producing such a core according to the preamble of claim 14.

Crude oil and natural gas deposits are present in porous geological formations. The permeability of the rock formation is crucial for the economic exploitation of these deposits. Frequently, the permeability of the rock formation falls over the period of extraction, so that the exploitation of the deposits becomes uneconomic; sometimes, the permeability is even too low from the outset. In these cases, the rock formation is broken up hydraulically by injecting liquids under sufficiently high pressure to generate stresses and consequently fractures and capillaries which improve the permeability.

In order to keep the geological formation open in a lasting manner even with declining pressure, proppants are additionally introduced.

Proppants are known, for example, from DE 19532844 C1. In this and other publications, the proppants consist of purely inorganic components with very high fractions of Al₂O₃, in order to achieve the formation of aluminosilicates or corundum. These minerals have a very high strength, which enables their use as a proppant even at great drilling depths with correspondingly high rock pressures. The aim here is to achieve a high sintering density (low porosity) in the granule by virtue of the selection of the starting materials and of the process parameters. Correspondingly, the density of these proppants is relatively high, so that they are deposited at an early stage as the rock formation is filled and do not reach the further regions. This further region is therefore not available for exploitation. Correspondingly, the positive effect achieved in ensuring the permeability of the rock formation is effective only for a narrow region in spite of the active rock mass pressure. The acid resistance of these proppants is low.

In addition, spherical granules are known from the expanded clay industry. The preferred granule size there is between 4-8 mm. The scatter in the granule size which is caused by technology factors also gives rise to a low percentage in the size range of 0.3-2 mm.

However, the roundness of the granules in this size range is unsuitable for use as a proppant, either coated or uncoated. The cause of this is that flakes of relatively large granules additionally accumulate in this size range.

In addition, the granules in this size fraction have significantly poorer strength than required. The reason lies in the technological processing of expanded clay production. There, maximum temperatures of approx. 1200° C. are achieved, which then lead correspondingly to the desired expansion of the granules. This expansion effect also occurs for this low size fraction, associated with a resulting excessively low strength owing to the excessively high porosity.

In addition, proppants which are produced by granulating pulverulent starting materials in combination with resins and subsequent curing of the resins are common knowledge. The liquid resin serves as a binder in the granulation. The advantage of this so-called composite is the very high acid resistance with sufficient strength. However, a disadvantage here is high production costs, since the yield in the size range needed, for example 20-40 mesh (depending on the application), is ≦35%. Accordingly, there is an additional disposal task for oversize and undersize.

Granules based on inorganic powders incorporated into a cured resin matrix also have densities of >2 g/cm³. The density in this case can be reduced only by adding organic materials.

It is an object of the invention to provide an improved core for use as a proppant with low density. In addition, a particularly suitable process for producing such a core should be specified.

The object regarding the core is achieved in accordance with the invention by a core having the features of claim 1. With regard to the process for producing such a core, the object is achieved by a process having the features of claim 14 or 15.

Advantageous embodiments of the invention are the subject matter of the subclaims.

The inventive core is formed from a raw material mixture which comprises at least one melt phase former and a further substance which comprises oxygen compounds, especially clay, the raw material mixture having an Al₂O₃ concentration of less than 35%.

Quantities in % should here and hereinafter always be understood as % by mass. By virtue of this low percentage, the formation of aluminosilicates or corundum in a thermal treatment is deliberately dispensed with. Instead, the aim is the formation of a mineral phase composition comparable to expanded clay. These mineral phases have a lower density than aluminosilicates or corundum. A core shall be understood to mean a ceramic structure which is spherical in a rough approximation.

In an alternative embodiment, the raw material mixture comprises, as a further substance, suitable ashes and/or dusts from thermal processes, for example brown coal filter ash or refuse incineration dusts, which means that less or no clay is required and, at the same time, other disposal routes for these ashes and dusts are dispensed with. The thermal treatment of clays forms a combustion product which is composed essentially of various oxides. Similar oxide mixtures are also formed in power stations and refuse incineration plants as a result of the thermal treatment in the form of ashes and dusts. It is therefore possible to replace the clay at least partly with these ashes and dusts.

According to the invention, the raw material components are mixed, granulated to form cores and then subjected to a thermal treatment, preferably in the temperature range from 800° C. to 1100° C. This achieves particularly high strength.

Alternatively, the mixing is effected so as to give rise to a suspension which is sprayed into a thermal reactor, especially a spray drier or a fluidized bed reactor, where the cores are formed. Subsequently, a thermal treatment takes place, preferably in the temperature range from 800° C. to 1100° C. The process conditions should be selected such that cores form in the desired size fraction. The advantage of this embodiment is that the yield of core material in the desired size fraction and the roundness of the cores are very high.

For the conditioning of the raw material mixture to give a suspension, the addition of a liquid medium may be advantageous.

According to the invention, the density of the core after a thermal treatment is less than 2.0 g/cm³. The density of a core is determined in a liquid medium, i.e. takes account of its open porosity. A low density is desirable in order to be able to transport the cores far into the geological formation and to prevent premature settling.

This is likewise contributed to by a low particle size in the range between 0.2 mm and 2 mm.

The use of melt phase formers, especially alkali metal carbonates and/or alkali metal hydroxides and/or alkali metal hydroxide solutions, in conjunction with a thermal treatment, preferably in a temperature range from 800° C. to 1100° C., contributes to a relatively high strength of the core, which is desired for a proppant. In addition, the use of a melt phase former results in the achievement of low apparent densities, but in particular low density owing to the closure of the open porosity by formation of a sufficient melt phase. Melt phase formers are added in the course of mixing or granulation. The use in liquid form eases and improves the homogenization of the raw material mixture.

The thermally treated core is preferably coated and/or impregnated. This serves to additionally increase the strength and to improve the acid resistance. A suitable coating achieves comparable acid resistances and strengths to those for composite cores, but here with densities of <2 g/cm³.

For the coating, there is the need for the size band of the core material to be smaller (for example 60 mesh to 20 mesh) than the desired size band of the coated end product (for example 40 mesh to 16 mesh). The difference in the size bands depends upon the layer thicknesses to be applied. When the size band of the core material is adjusted suitably, product yields of >60% are achieved. The economic efficiency of the production of coated proppant thus rises, because the material costs of the coating to be applied are usually significantly above those of the core material.

The surface of the core has to be particularly suitable for such a coating. For example, the penetration of coating material into the core has to be prevented. In addition, the surface has to have a certain roughness to enable adhesion of the coating and to prevent flaking on the end product.

In addition, the proportion of the melt phase former is less than 20% based on the dry raw material mixture, in order to obtain a particularly light core with a sufficiently high strength. According to the invention, especially in the surface region of the core material, the open porosity should be lowered or reduced completely. The basic prerequisite for this is the formation of a partial melt phase in the core in the region of the sintering zone. The formation of a sufficient melt phase fraction at sintering temperature is, in accordance with the invention, determined crucially by the type and quantity of melt phase former. In the thermal process in the range of heating up to the sintering zone, the temperature at the surface of the core is necessarily higher than in the interior. Accordingly, a higher proportion of melt phase is formed specifically at the surface. The process is controlled such that the higher proportion of melt phase at the core surface closes the pores, but the lower proportion of melt phase in the interior of the core leaves the pore structure very substantially unaffected.

The very substantial prevention of penetration of coating material into the core allows densities of the coated core of less than 2 g/cm³ to be achieved, since the density of the core otherwise increases as a result of the additionally penetrated coating material. Such a closed surface of the core additionally ensures saving of the coating or impregnation components. The type and quantity of the melt phase formers thus, in a crucial manner, constitute a prerequisite for the characteristic features of the resulting core.

Further lowering of the density is possible by adding suitable additives. Appropriately, organic materials, such as wood dusts, cereal flour, plastics granules or plastics dusts, are added to the raw material mixture for this purpose. These are combusted fully during the thermal treatment and thus ensure additional pore formation in the cores with the consequence of a lower density. Owing to the full combustion of the organic components, the thermally treated cores, in spite of the addition of organic materials to the raw material mixture, have to be characterized as exclusively inorganic core material.

Typically, the energy is supplied to the cores in the course of the thermal treatment in the rotary tube oven or fluidized bed externally, for example via a burner. Irrespective of this, however, it is also possible to supply a portion of the amount of heat needed to heat the cores up to the sintering temperature by virtue of a suitable composition of the raw material mixture.

For this purpose, liquid and/or solid high-energy organic substances are advantageously added to the raw material mixture in order to achieve intragranular energy release during the thermal process. The intragranular energy release is a simple additional means of heating the core. As a result of addition of high-energy components, for example of brown coal dust or oils, a portion of the energy required for heating is supplied by this means and hence less energy is required for the main heating. This is advantageous especially when the high-energy components are wastes. In addition, combustion of high-energy components forms pores which in turn have an advantageous effect on the density of the product. In one possible embodiment, the high-energy components are added in the formation of the cores, so that the components are in homogeneous distribution in the core. However, the high-energy components can also be supplied at another suitable point during the production process.

To increase the yield of cores in the desired fraction, assistants, for example plasticizers, demixers, deagglomerants, acids and/or bases, can be added to the formation of the cores. The aim here is the controlled change in the binding forces which form between the particles, for example between clay particles. These binding forces crucially determine the shape of the core which forms and the width of the size spectrum. For example, adjustment of the pH can determine whether the edges of the clay particles or the surfaces bond to one another. Consequently, the type of the structure which forms changes with the result of a change in the shape of the core (round or angular) and the strength of the bonding forces.

When the cores are to be formed by spraying into a thermal reactor, the necessary properties of a suspension, for example flow behaviour, can be established by adding suitable assistants, for example fluidizers.

The strength of the cores can be increased by using additional binders, for example sizes and/or celluloses. These may be added in solid and/or liquid form to the raw material mixture and/or to the liquid granulation or suspension medium (for example water). This is advantageous especially when the physical stress on the cores is high in the subsequent process steps and the binding action of the clay particles is insufficient for this stress. This is true in particular for the thermal treatment in a fluidized bed (or comparable thermal reactor).

A thermal treatment in a fluidized bed reactor reduces the agglomeration of the cores and thus increases the yield of utilizable cores.

Mixing and granulation can be effected in a mixer or granulator with addition of a granulating medium, preferably water. This may be followed downstream by further units, for example granulating pans, with the aim of improving the roundness of the cores.

To increase the yield of thermally treated cores in the necessary narrow size fraction, so-called seeds can be added to the raw material mixture before and/or during the granulation. The size band of these seeds is preferably below the size band of the desired size fraction of the fired core material. In one embodiment, the undersize of cores screened off before or after the thermal treatment can be used as a seed for the granulation.

In a further embodiment, a separating agent, especially quartz flour, limestone flour or dolomite flour, can be used in order to prevent lumping of the cores before or during the thermal treatment and thus to increase the yield of utilizable cores. To this end, the cores are powdered with the separating agent before the thermal treatment. Alternatively, the separating agent is blown into the combustion zone or sintering zone during the thermal treatment. For example, the separating agent is used to prevent agglomeration in the sintering zone in the maximum temperature range.

The cores can be treated thermally in any thermal reactor in which the necessary sintering temperatures of 800° C. to 1100° C. are achieved. This includes, for example, any conceivable embodiment of directly and indirectly heated rotary tube ovens, fluidized bed units, shaft ovens, etc.

In a preferred embodiment, the thermal treatment is followed by a cooling process.

The coating or impregnation of the cores preferably takes place during or after this cooling process, for example by spray application. In an advantageous manner, this can use the residual heat energy for the drying and/or curing of the applied layer.

Working examples of the invention are explained in detail with reference to drawings. In the drawings:

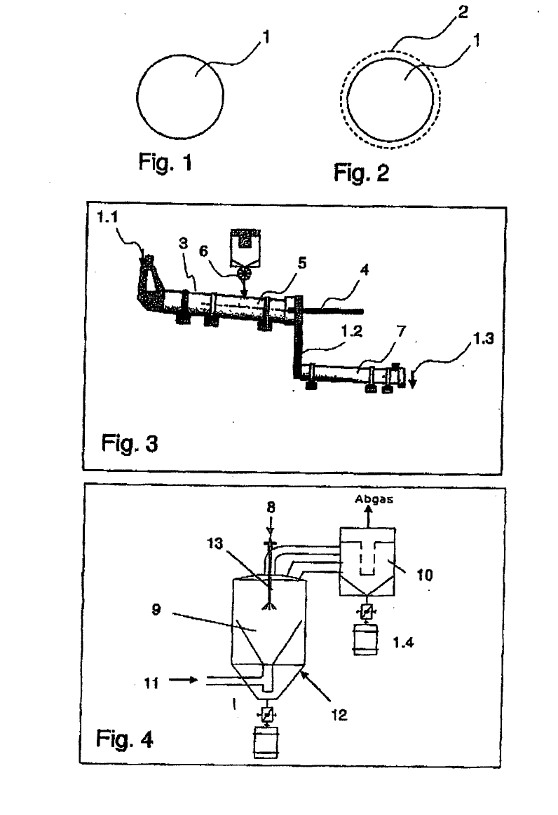

FIG. 1 shows a schematic section view of a core without coating,

FIG. 2 shows a schematic section view of a core with coating,

FIG. 3 shows a schematic view of a rotary tube oven unit for the thermal treatment, and

FIG. 4 shows a schematic view of a fluidized bed unit for the thermal treatment.

Parts corresponding to one another are provided with the same reference symbols in all figures.

FIG. 1 shows an embodiment of a core 1. The core 1, essentially with spherical dimensions, is without coating in the embodiment here. The core 1 is shown as a cured core in the thermally treated state which is formed from a raw material mixture of clay and a melt phase former, the raw material mixture having an Al₂O₃ concentration of less than 35%. The core 1 has a density of less than 2 g/cm³ in the thermally treated state.

FIG. 2 shows an embodiment of a core 1 with a coating 2. The ceramic, essentially spherical core 1 may be surrounded by a coating 2, as indicated by the dotted line.

The core 1 is formed at least from clay and a melt phase former. The clay contains less than 35% Al₂O₃, so that no aluminosilicates or corundum are formed. A particularly advantageous embodiment of the core 1 involves a clay which has a proportion of less than 25% Al₂O₃. Instead of clay, it is also possible to use ashes or dusts from thermal processes.

In order to obtain a particularly light core 1 with a sufficiently high strength, the proportion of the melt phase former is less than 20%, based on the dry total mass. The melt phase formers used are, for example, alkali metal carbonates and/or alkali metal hydroxides.

As a result of the composition of the raw material mixture of the core 1 and as a result of its subsequent thermal treatment, a core 1 forms, which has a density of less than 2 g/cm³ and a diameter of 0.2 mm to 2 mm.

Depending on the use and function, the core 1 may then additionally be coated or impregnated.

The coating 2 consists of a resin or resin mixture with or without additional components for enhancing the networking capacity, for example rock flours.

FIG. 3 shows a rotary tube oven 3 as an example of a possible embodiment of a unit for the thermal treatment of the thermally untreated cores 1.1 (also known as green granule). An untreated core 1.1 with the above-described composition composed of clay and melt phase former is supplied to the thermal process after the granulation. The rotary tube oven 3 can be heated indirectly, for example by external electrical heating rods, or directly, for example by a burner. Alternatively, a fluidized bed reactor can be used instead of a rotary tube oven 3.

The working example according to FIG. 3 shows a rotary tube oven 3 with direct firing by a burner 4. The untreated cores 1.1 are supplied to the rotary tube oven 3 and treated thermally in the sintering zone 5 heated by the burner 4. A separating agent 6, for example quartz flour, limestone flour or dolomite flour, can additionally be introduced into the sintering zone 5. The thermally treated cores 1.2 (also known as fired cores) are removed from the rotary tube oven 3 and cooled in the drum cooler 7. At the end of the drum cooler 7, the cooled cores 1.3 (also known as cold cores), as required, may be packaged or sent to a further treatment step, for example a coating or impregnation process. The coating can alternatively also be effected during the cooling process, for example by spray application.

FIG. 4 shows a fluidized bed unit 12 as an example of a possible embodiment for a unit for producing the desired core shape and the thermal treatment of these cores 1.

A suitable suspension (slip) 8 is produced from the raw material mixture with composition described above. To this end, a suitable liquid medium, preferably water, is added to the raw material mixture. To establish the necessary properties of the suspension 8, for example flow behaviour, suitable assistants, for example fluidizers, can be added. Moreover, additional binders, for example sizes, may be part of the suspension 8 prepared.

This suspension 8 is introduced in a suitable manner into the fluidized bed reactor 12 via a two-material nozzle 13 continuously in such a way that highly spherical particles with a narrow particle distribution form as far as possible within the desired size band.

The process gas needed is generated in a hot gas generator 11. A separator 10 is adjusted such that only thermally treated cores 1.2 with the desired particle size are discharged. Excessively small, thermally treated cores 1.2 pass back into the reaction chamber 9 as seeds. At the end of the separator 10, the cooled cores 1.4, as required, can be packaged or sent to a further treatment step, for example a coating or impregnation process.

Some preferred working examples for the production of cores 1 by the above-described process are detailed below:

### WORKING EXAMPLE 1

In Working Example 1, for the cores 1, as components of the raw material mixture, clay (Al₂O₃ concentration=22.93%) with a mass fraction of 96% and sodium bicarbonate as a melt phase former with a mass fraction of 4% are mixed homogeneously in a mixer. Subsequently, the homogenized dry raw material mixture is granulated by adding water with a proportion of 12%.

The resulting untreated cores 1.1 (green granule) are then introduced into the rotary tube oven 3. The maximum temperature in the sintering zone 5 is 1000° C.±10° C. Subsequently, the thermally treated cores 1.2 are cooled in the drum cooler 7 to <100° C. The screened-off fraction of the treated and cooled cores 1.3 with a screen (40-20 mesh) has the following product specification:

TABLE 1
Core without coating (Working Example 1)

| | | | |
|---|---|---|---|
| Apparent density | | [g/cm³] | 0.80 |
| Density | to API RP 58 | [g/cm³] | 1.75 |
| Crash test | to API RP 60 | [%] | 8.5 |
| | (at 2000 psi) | | |
| Roundness | to API RP 58 | [—] | 0.8/0.8 |
| Acid solubility | to API RP 58 | [%] | 10.3 |

API RPs are specifications of the American Petroleum Institute which recommends test conditions for bulk materials. API RP 60 recommends test conditions for high-strength proppants which are used for hydraulic fracturing.

The screened cores 1 (60 mesh to 30 mesh) were then coated with a mixture of resin and feldspar flour. The layer thickness was approx. 22 μm. Subsequently, thermal curing was effected in a fluidized bed reactor. The screened-off fraction (40 mesh to 20 mesh) of the resulting coated cores 1 has the following product properties:

TABLE 2
Coated cores (Working Example 1)

| | | | |
|---|---|---|---|
| Apparent density | | [g/cm³] | 0.91 |
| Density | to API RP 58 | [g/cm³] | 1.80 |
| Crash test | to API RP 60 | [%] | 0.85 |
| | (at 2000 psi) | | |
| Roundness | to API RP 58 | [—] | 0.9/0.9 |
| Acid solubility | to API RP 58 | [%] | 1.9 |
| Opacity | to API RP 56 | [NTU] | 158 |

### WORKING EXAMPLE 2

A further working example which is based essentially on the raw material mixture of Working Example 1 is described below. As a result of addition of a cereal flour, the increase in the porosity is achieved with the aim of a lower density of the combustion product, i.e. of the core 1.2. The cereal flour is combusted completely during the thermal treatment, so that the thermally treated core 1.2 is a purely inorganic product.

In detail, for the core 1, as components of the raw material mixture, clay (Al₂O₃ concentration=22.93%) with a mass fraction of 93%, sodium bicarbonate (melt phase former) with a mass fraction of 3% and wheat flour with a mass fraction of 3% are mixed homogeneously in a mixer. Subsequently, the homogenized dry raw material mixture is granulated by adding water with a fraction of 16%.

The resulting untreated cores 1.1 (green granule) are introduced into the rotary tube oven 3. The maximum temperature in the sintering zone 5 is 1000° C.±10° C. Subsequently, the thermally treated cores 1.2 are cooled in the drum cooler 7 to <100° C.

The screened-off fraction of the cooled cores 1.3 with 40 mesh to 20 mesh has the following product specification:

TABLE 3
Core without coating (Working Example 2)

| | | | |
|---|---|---|---|
| Apparent density | | [g/cm³] | 0.75 |
| Density | to API RP 58 | [g/cm³] | 1.60 |
| Crash test | to API RP 60 | [%] | 14.5 |
| | (at 2,000 psi) | | |
| Roundness | to API RP 58 | [—] | 0.8/0.8 |
| Acid solubility | to API RP 58 | [%] | 11.4 |

These cores 1 were then coated with a mixture of ground glass and phenol resin (62.8% core material/22.7% ground glass/13.5% phenol resin). The resin was cured in the same way as in Working Example 1. The screened-off fraction of the coated cores with 40-20 mesh exhibits the following product specification:

TABLE 4
Coated cores (Working Example 2)

| | | | |
|---|---|---|---|
| Apparent density | | [g/cm³] | 0.85 |
| Density | to API RP 58 | [g/cm³] | 1.61 |
| Crash test | to API RP 60 | [%] | 1.45 |
| | (at 2000 psi) | | |
| Roundness | to API RP 58 | [—] | 0.9/0.9 |
| Acid solubility | to API RP 58 | [%] | 2.2 |
| Opacity | to API RP 56 | [NTU] | 171 |

### WORKING EXAMPLE 3

A further working example is described below. Instead of a solid melt phase former, a liquid melt phase former is added to the clay.

In detail, for the cores 1, as a component of the raw material mixture, clay (Al₂O₃ concentration=22.93%) is introduced into a mixer. Subsequently, dilute sodium hydroxide solution is added as a melt phase former. The amount of the NaOH solution corresponds exactly to the amount of solvent, for example 11.5% based on clay, which is needed for granulation. The concentration of the dilute NaOH solution was adjusted beforehand so as to attain a concentration ratio between clay and Na₂O from NaOH solution of 97.5%:2.5% as a result of the amount added.

The untreated cores 1.1 (green granule) are introduced into the rotary tube oven 3. The maximum temperature in the sintering zone 5 is 1000° C.±10° C. Subsequently, the thermally treated cores 1.2 are cooled in the drum cooler 7 to <100° C.

The screened-off fraction with 40 mesh to 20 mesh of the cooled cores 1.3 has the following product specification:

TABLE 5
Cores without coating (Working Example 3)

| | | | |
|---|---|---|---|
| Apparent density | | [g/cm³] | 0.80 |
| Density | to API RP 58 | [g/cm³] | 1.78 |
| Crash test | to API RP 60 | [%] | 10.5 |
| | (at 2000 psi) | | |
| Roundness | to API RP 58 | [—] | 0.8/0.8 |
| Acid solubility | to API RP 58 | [%] | 10.4 |

These cores 1 were then coated with phenol resin (93% core material/7% phenol resin). The resin was cured in the same way as in Working Example 1. The screened-off fraction of the coated cores with 40 mesh to 20 mesh exhibits the following product specification:

TABLE 6
Coated cores (Working Example 3)

| | | | |
|---|---|---|---|
| Apparent density | | [g/cm³] | 0.86 |
| Density | to API RP 58 | [g/cm³] | 1.65 |
| Crash test | to API RP 60 | [%] | 1.65 |
| | (at 2000 psi) | | |
| Roundness | to API RP 58 | [—] | 0.8/0.8 |
| Acid solubitity | to API RP 58 | [%] | 3.1 |
| Opacity | to API RP 56 | [NTU] | 164 |

### WORKING EXAMPLE 4

In Working Example 4, a suspension (slip) was prepared from the components of the raw material mixture

90% clay flour

4% Na₂CO₃

6% cellulose

by adding water. This slip is subsequently sprayed into a fluidized bed reactor in such a way that cores of the desired shape form. The temperature of the material layer in the fluidized bed is 80° C.±5° C. A classifier is used to continuously remove the desired size fraction of the cores (40 mesh to 20 mesh).

These untreated cores 1.1 (green granule) are introduced into the rotary tube oven 3. The maximum temperature in the sintering zone 5 is 1000° C.±10° C. Subsequently, the cores 1.2 are cooled in the drum cooler 7 to <100° C.

The screened-off fraction of the treated and cooled cores 1.3 with a screen (40 mesh to 20 mesh) has the following product specification:

TABLE 7
Cores without coating (Working Example 4)

| | | | |
|---|---|---|---|
| Apparent density | | [g/cm³] | 0.81 |
| Density | to API RP 58 | [g/cm³] | 1.81 |
| Crash test | to API RP 60 | [%] | 12.3 |
| | (at 2000 psi) | | |
| Roundness | to API RP 58 | [—] | 0.9/0.9 |
| Acid solubility | to API RP 58 | [%] | 1.81 |

These cores 1 can then be coated analogously to Working Examples 1 to 3 or otherwise.

### WORKING EXAMPLE 5

The size distribution and hence the yield in the desired size range depend, in addition to the process technology parameters such as fluidization rate, mixing time, etc., crucially on the active binding forces between the individual particles. Addition of suitable assistants (additives) allows influence on the binding forces between the individual particles and hence active change in the size spectrum.

The granulation of the raw material mixture in a mixer (with a speed of 4000 rpm) with water as the liquid medium (15% based on dry mixture) results in a yield in the desired size range (0.3 mm to 1 mm) of 32%.

When NaOH is added to the water beforehand so as to attain a 10% sodium hydroxide solution, the yield in the 0.3 mm to 1 mm size fraction with the same mixer parameters increases to 51%.

1. A core which is formed from a raw material mixture comprising a melt phase former and at least one further substance which comprises oxygen compounds, wherein the raw material mixture containing less than 35% Al₂O₃.

2. The core of claim 1 wherein the further substance comprises clay.

3. The core of claim 1 wherein the further substance comprises ashes or dusts from thermal processes.

4. The core of claim 1 wherein the core has a density of less than 2 g/cm³ when in a thermally treated state.

5. The core of claim 1 wherein the core has a particle size of 0.2 mm to 2 mm when in a thermally treated state.

6. The core of claim 1 wherein an organic material is added to the raw material mixture.

7. The core of claim 1 wherein liquid or solid high-energy organic substances are added to the raw material mixture.

8. The core of claim 1 wherein the melt phase former in the raw material mixture being less than 20%.

9. The core of claim 1 wherein the melt phase former is in liquid or solid form and comprises alkali metal carbonates, alkali metal hydroxides, alkali metal hydroxide solutions or combinations thereof.

10. The core of claim 1 further comprising a coating.

11. The core of claim 10, wherein the coating comprises an inorganic or organic material.

12. The core of claim 1 further comprising an impregnation of the core in the.

13. (canceled)

14. A process for producing the core of claim 1 comprising mixing the raw material components and granulating to form cores then subjecting the cores to a thermal treatment in the temperature range from 800° C. to 1100° C.

15. A process for producing the core of claim 1 comprising mixing the raw material components and conditioning to form a suspension, spraying the suspension into a thermal reactor then subjecting the cores to a thermal treatment in the temperature range from 800° C. to 1100° C.

16. The process of claim 14 further comprising adding a liquid medium before, during or after the mixing.

17. The process of claim 14 further comprising adding liquid or solid assistants before, during or after the mixing.

18. The process of claim 14 further comprising treating the cores in a granulating pan before the thermal treatment.

19. The process of claim 14 further comprising adding seeds to form the cores.

20. The process of claim 14 further comprising utilizing a separating agent.

21. The process of claim 20 further comprising powdering the cores with the separating agent before the thermal treatment.

22. The process of claim 20 wherein the separating agent is blown into the sintering zone (5) during the thermal treatment.

23. The process of claim 14 wherein thermal treatment takes place in a countercurrent rotary tube oven which is heated directly or indirectly.

24. The process of claim 14 wherein the thermal treatment takes place in a fluidized bed.

25. The process of claim 14 further comprising coating or impregnating the cores.

26. The process of claim 14 further wherein the thermal treatment is followed by a cooling process.

27. The process of claim 26 wherein after the cooling process the cores are coated or impregnated.

28. The process of claim 26 wherein during the cooling process, the cores are coated or impregnated.
